(19) United States
(12) Patent Application Publication
(10) Pub. No.: US 2025/0283000 A1
(43) Pub. Date: Sep. 11, 2025

(54) SYSTEMS AND PROCESSES FOR FLUIDIZED CATALYTIC CRACKING (FCC)

(71) Applicant: T.EN Process Technology, Inc., Houston, TX (US)

(72) Inventors: Yongcan Gao, Houston, TX (US); Scott Golczynski, Houston, TX (US); Steven Shimoda, Houston, TX (US); Siyi Lai, Houston, TX (US)

(73) Assignee: T.EN Process Technology, Inc., Houston, TX (US)

(21) Appl. No.: 18/599,792

(22) Filed: Mar. 8, 2024

(51) Int. Cl. C10G 11/18; B01J 8/18; B01J 8/26; C01B 3/02; C10J 3/82

(52) U.S. Cl. CPC C10G 11/182; B01J 8/1827; B01J 8/1836; B01J 8/1863; B01J 8/26; C01B 3/02; C10J 3/82

(57) ABSTRACT

A fluid catalytic cracking process includes regenerating a spent catalyst from a stripper vessel in a first regeneration stage to produce a partially regenerated catalyst, regenerating the partially regenerated catalyst in second regeneration stage to produce a fully regenerated catalyst, and providing a first portion of the fully regenerated catalyst to a riser reactor. The process includes generating the spent catalyst with the riser reactor and providing the spent catalyst to a stripper vessel and providing a second portion of the fully regenerated catalyst to the stripper vessel to mix with the spent catalyst for better stripping efficiency and prompting further reactions, resulting in overall reduced coke load, sulfur, and nitrogen to be burned, and providing necessary heat needed for the following coke gasification to produce synthesis gas in the first regeneration stage.

### BACKGROUND OF THE INVENTION

### Field of the Invention

The present disclosure relates to Fluidized Catalytic Cracking (FCC) and more particularly to stripping in FCC systems.

### Description of Related Art

The Fluidized Catalytic Cracking (FCC) process is a chemical process commonly used in oil refineries, the purpose of which is to convert heavy, high molecular weight hydrocarbon materials into lighter lower molecular weight hydrocarbon fractions. In this type of process, a hydrocarbon feedstock is vaporized at high temperatures and at the same time placed in contact with the particles of the cracking catalyst maintained in suspension in the feedstock vapor and entrained thereby. After the cracking reactions have produced the desired molecular weight range with a corresponding drop in boiling points, the product vapor obtained is separated from the catalyst particles. The particles are subsequently stripped to recover any entrained hydrocarbons, regenerated by burning the coke formed thereon and recycled by once again being placed in contact with the feedstock to be cracked.

Stripping is one of the determining steps in the FCC process. In fact, insufficient stripping results in the reactor effluent remaining on and in between the catalyst particles so that during the regeneration step an additional combustion load is imposed upon the regenerator with excessive heat production beyond the heat needed to drive the catalytic reaction. As a result, the combustion of entrained hydrocarbon vapors into the regenerator represents a loss in final yield of converted product.

In a FCC process the stripping of the catalyst particles typically takes place in a deep fluidized bed to promote vigorous mixing, intimate contact of fluid streams and catalyst particles within a vessel and to provide sufficient residence time for stripping. Baffles and packing have been used to achieve the desired contact. Fluidized beds are usually generated by passing a fluid stream, typically a vapor stream, upwardly through a bed of solid particles at a flow rate sufficient to suspend the particles and cause a gas solid mixing within the bed.

Generally, after reactor effluents are separated from the catalyst particles, the particles are directed to a stripping chamber where stripping takes place in a descending dense fluidized phase. A gaseous fluid injected at the bottom of the chamber is used to fluidize the coked catalyst particles and displace the entrained hydrocarbons located in the interstitial spaces between the particles. It is preferential to use a polar material, such as steam, for this gaseous fluid, as it is more strongly adsorbed by the catalyst particles and thus the hydrocarbons are more readily displaced. Finally, the stripped catalyst particles are transferred to the regeneration zone.

Different methods for hotter staged stripping have been proposed. For example, U.S. Pat. No. 5,000,841 describes hotter staged stripping methods by direct blending hot regenerated catalyst with FCC spent catalyst in FCC stripper. The hotter catalyst mixture between spent catalyst and hotter regenerated catalyst is targeted from 55° C. above ROT to 760° C. at first/upper stage stripper, and then catalyst mixtures were further required to be cooled at least by 30° C. at second/lower stage stripper blended directly with cooled catalyst before their entering regenerator on purpose without interferences to FCC regenerator operation.

In another hotter staged stripping described in U.S. Pat. No. 5,128,109, hot regenerated catalyst is directly blended with a FCC spent catalyst in a FCC stripper. The hotter catalyst mixture between spent catalyst and hotter regenerated catalyst were targeted from 55° C. above ROT to 760° C. at first/upper stage stripper, and then catalyst mixtures were further required to be cooled at least by 30° C. at second/lower stage stripper with cooler (optionally even a separator vessel) before their entering regenerator on purpose without interferences to FCC regenerator operation.

An FCC unit regenerator in oxycombustion mode is described U.S. Pat. No. 4,542,114. In U.S. Pat. No. 4,542,114, the operation of an FCC unit regenerator uses a flow of pure O₂ diluted with the aim of generating a flow of effluents rich in CO₂ to avoid temperature peaks and deficient fluidization of catalyst inside the regenerator. U.S. Pat. No. 4,542,114 also may require the use of large-scale equipment and extra energy consumption to reprocess and recycle the amount of CO₂ necessary to adjust the regenerator operations because it did not provide effective measures to reduce coke yield and contaminant emissions of SOₓ and NOₓ.

U.S. Pat. No. 5,362,380 describes ways to convert the carbon on an FCC catalyst to a gaseous mixture of CO₂, CO, CH₄, and H₂ by steam reforming. U.S. Pat. No. 5,362,380 reports reaction conditions of temperatures from 537-650° C., steam to carbon molar ratios of 0.5-20 (preferably about 2-6) and reaction times from 0.5 to 30 minutes. They report that 10-40% of the carbon can be removed by these steam treatments. It is described that the remaining carbon is removed from the catalyst by a 2^{nd} regeneration treatment with oxygen-contained medium, such as, air. In a fluid catalytic pilot plant steam was injected into the steam stripper in the absence of oxygen at temperatures from 590-650° C. No effective or extra measures were provided for targeted steam gasification at temperatures of 537-650° C. with oxygen-free gas when FCC unit ROT was run below 537° C. Moreover, no effective or extra measures to reduce coke yield and contaminant emissions of SOₓ and NOₓ are utilized.

U.S. Pat. Nos. 5,000,841 and 5,128,109 describe the two opposite actions of heating up and cooling down in the FCC stripper section. Moreover, neither integrate FCC coke gasification and oxycombustion for higher carbon utility efficiency.

U.S. Pat. No. 7,932,204 describes the operation of an FCC unit with two-staged regenerator to produce synthesis gas at preferable a counter-current manner between regeneration gas and catalyst. The first stage regenerator can be run at gasification-like condition with oxygen deficient regeneration gas sourced from the second stage regenerator at temperature between 705° C. and 815° C. (1300° F. and 1500° F.) and pressure at between 1.36 and 3.4 atmosphere (20 and 50 psig) under partial regeneration mode. While the second stage regenerator can react between partial regenerated catalyst from the first stage regenerator and combustion gas containing oxygen in the presence of steam and/or CO₂ at temperature between 675° C. and 735° C. (1250° F. and 1350° F.) and pressure at between 1.7 and 3.4 atmosphere (25 and 50 psig) at complete regeneration mode. Preheated regeneration gas to the second stage regenerator was preferably proposed over 537° C. (1000° F.) to assist in producing a quality syngas. In U.S. Pat. No. 7,932,204, it may be difficult to accurately control first stage regenerator to run at partial combustion mode (oxygen-deficient/gasification-like condition) while second stage regenerator is required to operate at complete combustion mode (in which, excessive oxygen will be existed) because second stage regenerator flue gas is used as feed gas to first stage regenerator. In U.S. Pat. No. 7,932,204, the first stage regenerator cannot run at oxygen-deficient condition at higher temperature (between 705° C. and 815° C. (1300° F. and 1500° F.) without extra heat input because the second stage regenerator is operated at relative lower temperature range (temperature between 675° C. and 735° C. (1250° F. and 1350° F.)) at the current stacked regenerator configuration. This disclosure also fails to provide effective or extra measures to reduce coke yield and contaminant emissions of SOₓ and NOₓ.

Another FCC unit is described in U.S. Patent Publication No. 2011/0155642. In this publication, the FCC unit includes a “riser” regenerator with pure O₂ or an optional high oxygen-enriched mixture of O₂ and CO₂ as regeneration gas. To control the temperature throughout the riser regenerator and avoid the occurrence of hot spots, multiple injections of oxygen along the “riser” regenerator was proposed as well as the addition of an extra catalyst cooler. The spent catalyst reconditioner for mixture of spent catalyst and hotter regenerated catalyst will result in much hotter catalyst (50-100° C. higher than conventional stripper operation) to the bottom riser regenerator. This scheme may destroy the intention to control the temperature throughout the riser regenerator and avoid the occurrence of hot spots when pure O₂ or an optional high oxygen-enriched mixture of O₂ and CO₂ is used as regeneration gas.

Such conventional methods and systems have generally been considered satisfactory for their intended purpose. However, there is still a need in the art for improved packing elements and systems. Additional objects of the embodiments of the present disclosure will become apparent from the following summary and detailed discussion.

### SUMMARY OF THE INVENTION

A fluid catalytic cracking process includes regenerating a spent catalyst from a stripper vessel in a first regeneration stage to produce a partially regenerated catalyst, regenerating the partially regenerated catalyst in second regeneration stage to produce a fully regenerated catalyst, and providing a first portion of the fully regenerated catalyst to a riser reactor. The process includes generating the spent catalyst with the riser reactor and providing the spent catalyst to a stripper vessel and providing a second portion of the fully regenerated catalyst to the stripper vessel to mix with the spent catalyst for better stripping efficiency and prompting further reactions, resulting in overall reduced coke load, sulfur, and nitrogen to be burned, and providing necessary heat needed for the following coke gasification to produce synthesis gas in the first regeneration stage.

In an embodiment of the above, the stripper vessel is operated at a temperature ranging from 500° C. (932° F.) to 820° C. (1508° F.).

In a further embodiment of any of the above, is contemplated that the stripper vessel is operated at a pressure ranging from 12-30 psig (0.83-2.07 barg).

In a further embodiment of any of the above, a stripper bed within the stripper vessel has a temperature from 55° C. (122° F.) above ROT to 815° C. (1500° F.), or preferably from 83° C. (150° F.) above ROT to 760° C. (1400° F.), or, in a further embodiment of any of the above, preferably from 100° C. (212° F.) above ROT to 732° C. (1350° F.).

In a further embodiment of any of the above, the spent catalyst residence time in the stripper vessel ranges from 0.5-7 minutes.

In a further embodiment of any of the above, the spent catalyst residence time in the stripper vessel ranges from 1-3 minutes.

In a further embodiment of any of the above, the ratio of the fully regenerated catalyst to the spent catalyst in the stripper vessel ranges from 0.3:1 to 0.7:1.

In a further embodiment of any of the above, the ratio of the fully regenerated catalyst to the spent catalyst in the stripper vessel ranges from 1:5 to 5:1.

In a further embodiment of any of the above, the ratio of the fully regenerated catalyst to the spent catalyst in the stripper vessel ranges from 1:10 to 10:1.

In a further embodiment of any of the above, the process includes running the first regeneration stage as a gasifier.

In a further embodiment of any of the above, the first regeneration stage includes a raw synthesis gas outlet line.

In a further embodiment of any of the above, the process includes reacting a portion of the spent catalyst stream from the stripper vessel with gasification gas in the first regeneration stage to produce raw synthesis gas.

In a further embodiment of any of the above, the raw synthesis gas includes at least one of CO, H₂, CO₂, H₂O, COS, H₂S, SOₓ, NOₓ or unreacted O₂.

In a further embodiment of any of the above, is contemplated that the oxygen concentration for the raw synthesis gas is 0.2 mol % (Dry basis), or preferably no remaining oxygen.

In a further embodiment of any of the above, regenerating the spent catalyst from the stripper vessel in the first regeneration stage includes reacting the spent catalyst with gasification gas to produce the partially regenerated catalyst.

In a further embodiment of any of the above, gasification gas is an artificially created mixture comprising at least one of i) oxygen and steam, ii) oxygen and CO₂, or iii) steam, oxygen and CO₂.

In a further embodiment of any of the above, concentration levels for these three main components range from 0 to 50 mol % for oxygen, 0 to 75 mol % for CO₂, and 0 to 75 mol % for steam.

In a further embodiment of any of the above, concentration levels for these three main components range from 25 to 30 mol %, 70 to 75 mol %, and 0 to 75 mol % for steam.

In a further embodiment of any of the above, concentration levels range from around 30 mol % for oxygen and 70 mol % for CO₂ on a dry basis.

In a further embodiment of any of the above, the process includes running the second regeneration stage as a complete regenerator.

In a further embodiment of any of the above, the second regeneration stage includes a flue gas outlet line.

In a further embodiment of any of the above, the process includes feeding the partially regenerated catalyst to the second regeneration stage through a catalyst transfer line.

In a further embodiment of any of the above, providing the first portion of the fully regenerated catalyst to the riser reactor includes feeding the first portion of the fully regenerated catalyst through a regenerated catalyst transfer line with a control valve.

In a further embodiment of any of the above, providing the second portion of the fully regenerated catalyst to the stripper vessel includes feeding the second portion of the fully regenerated catalyst through a catalyst transfer line with a control valve.

In a further embodiment of any of the above, in the stripper vessel, the counter-current between the catalyst and stripping media, preferably stripper superficial medium (preferably steam), ranges from 0.5 fps (157 mm/s) to 1.0 fps (305 mm/s).

In a further embodiment of any of the above, the process includes providing heat exchange between hot flue gas/syngas and stripper gas for high stripper temperature if needed.

In a further embodiment of any of the above, the first regeneration stage operates at a targeted gasification condition temperature ranging from 705° C. (1300° F.) to 820° C. (1508° F.).

In a further embodiment of any of the above, the first regeneration stage operates at a targeted gasification condition temperature ranging from 750° C. (1382° F.) to 815° C. (1500° F.).

In a further embodiment of any of the above, the first regeneration stage operates at a targeted gasification condition pressure ranging from 20 psig (1.38 atm) to 50 psig (3.45 atm).

In a further embodiment of any of the above, the first regeneration stage operates at a targeted gasification condition pressure ranging from 30-35 psig (2.1-2.4 barg).

In a further embodiment of any of the above, the residence time for the spent catalyst in the first regeneration stage ranges from 0.5-30 minutes.

In a further embodiment of any of the above, a residence time for the spent catalyst in the first regeneration stage ranges from 2-15 minutes.

In a further embodiment of any of the above, in the first regeneration stage, the counter-current between the catalyst and gasification gas has a superficial velocity of gasification gas preferably set at 2 fps (0.6 m/s) −4 fps (1.2 m/s).

In a further embodiment of any of the above, the process includes supplying a heat source to the gasification gas in the first regeneration source.

In a further embodiment of any of the above, the process includes exchanging heat between hot flue gas/syngas and gasification gas to heat the gasification gas to a temperature above 425° C. (800° F.), preferably above 537° C. (1000° F.).

In a further embodiment of any of the above, the second regeneration stage operates at a targeted regeneration temperature ranging from 675° C. (1250° F.) to 815° C. (1500° F.).

In a further embodiment of any of the above, the second regeneration stage operates at a targeted regeneration temperature ranging from 704° C. (1300° F.) to 800° C. (1472° F.).

In a further embodiment of any of the above, the second regeneration stage operates at a targeted regeneration temperature ranging from 725° C. (1337° F.) to 760° C. (1400° F.) with a catalyst cooler(s) if needed.

In a further embodiment of any of the above, the second regeneration stage operates at a pressure ranging from 15 psig (1.03 atm) to 50 psig (3.45 atm).

In a further embodiment of any of the above, the second regeneration stage operates at a pressure ranging from 17 to 20 psig (1.17-1.38 barg).

In a further embodiment of any of the above, the residence time for the partially regenerated catalyst in the second regeneration stage ranges from 0.5-10 min.

In a further embodiment of any of the above, a residence time for the partially regenerated catalyst in the second regeneration stage ranges from 2-5 min.

In a further embodiment of any of the above, the superficial velocity of regeneration gas, in the counter-current between the catalyst and regeneration gas, is set at 2 fps (0.6 m/s) −4 fps (1.2 m/s). The regeneration gas can be an artificially created mixture comprising (1) pure oxygen, (2) oxygen and CO₂, and/or a mixture of oxygen and CO₂.

In a further embodiment of any of the above, the concentration levels for the mixture of oxygen and CO₂ can range from 0 to 50 mol % for oxygen (or, in a further embodiment of any of the above, preferably around 25 to 30 mol %), 0 to 75 mol % for CO₂ (or, in a further embodiment of any of the above, preferably around 70 to 75 mol %).

In a further embodiment of any of the above, the regeneration gas is around 30 mol % oxygen and 70% CO₂ on a dry basis.

In accordance with another aspect, a fluid catalytic cracking system includes a stripper vessel having a spent catalyst outlet. A first regeneration stage is downstream from the spent catalyst outlet and configured and adapted to regenerate a spent catalyst from the stripper vessel. The system includes a second regeneration stage downstream from the first regeneration stage. The second regeneration stage is configured and adapted to fully regenerate a partially regenerated catalyst from the first regeneration stage. The second regeneration stage is in fluid communication with the stripper vessel. The system includes a riser reactor upstream from the stripper vessel and in fluid communication with the second regeneration stage. The riser reactor configured and adapted to receive a first portion of a fully regenerated catalyst from the second regeneration stage. The stripper vessel is configured and adapted to receive a spent catalyst from the riser reactor and a second portion of a fully regenerated catalyst from the second regeneration stage to mix with the spent catalyst for better stripping efficiency and prompting further reactions.

In a further embodiment of the FCC system above, the system includes a supplemental heat source in thermal communication with the stripper vessel.

In a further embodiment of any of the above, the first regeneration stage includes a raw synthesis gas outlet line.

In a further embodiment of any of the above, the raw synthesis gas can be similar to that described above for the FCC process.

In a further embodiment of any of the above, the second regeneration stage includes a flue gas outlet line.

In a further embodiment of any of the above, the system includes a catalyst transfer line for fluidly connecting the first regeneration stage to the second regeneration stage.

In a further embodiment of any of the above, the system includes a regenerated catalyst transfer line for fluidly connecting the second regenerator stage to the riser reactor.

In a further embodiment of any of the above, the system includes a regenerated catalyst transfer line for fluidly connecting the second regenerator stage to the stripper vessel.

In a further embodiment of any of the above, the first regeneration stage operating temperature and pressure are similar to that described above for the FCC process.

In a further embodiment of any of the above, the second regeneration operating temperature and pressure can be similar to that described above for the FCC process.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic depiction of a fluid catalytic cracking system constructed in accordance with an embodiment of the present disclosure, showing a riser reactor, stripper vessel, a first regeneration stage and a second regeneration stage.

### DETAILED DESCRIPTION OF THE PREFERRED EMBODIMENTS

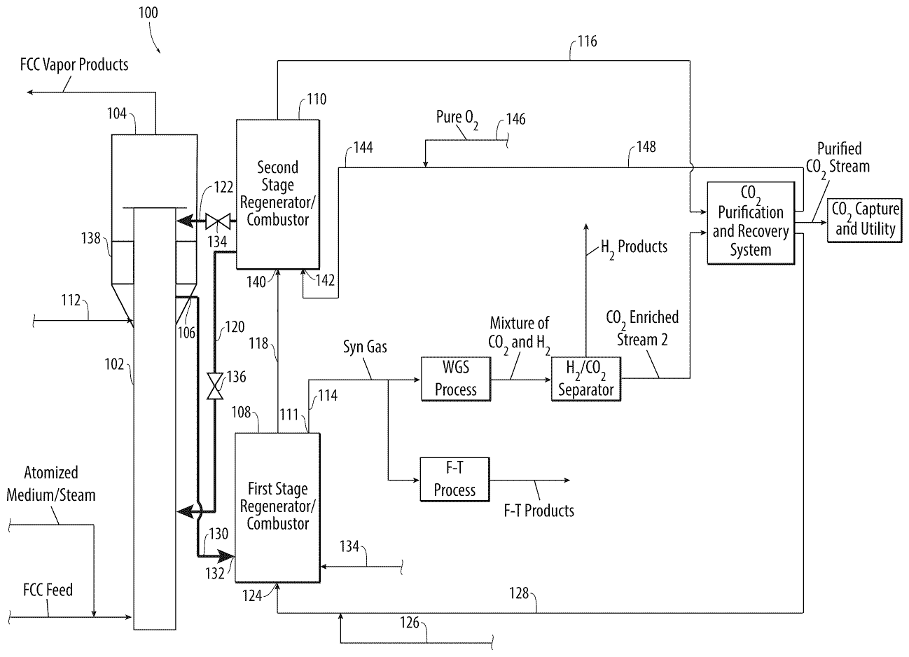

Reference will now be made to the drawings wherein like reference numerals identify similar structural features or aspects of the subject disclosure. For purposes of explanation and illustration, and not limitation, a schematic view of an exemplary embodiment of the fluid catalytic cracking system in accordance with the disclosure is shown in FIG. 1 and is designated generally by reference character 100. Other embodiments of the fluid catalytic cracking systems and processes in accordance with the disclosure, or aspects thereof, will be described. The systems and methods described herein provide a fluid catalytic cracking system with integrated coke gasification, staged oxycombustion and hotter stripping ability that results in high carbon utility efficiency, and reduced CO₂ and contaminant emissions of SOₓ and NOₓ.

As shown in FIG. 1, a fluid catalytic cracking system 100 includes a riser reactor 102 and a stripper vessel 104 downstream from riser reactor 102. Stripper vessel 104 includes a spent catalyst outlet 106. System 100 includes a spent catalyst transfer line 130 to fluidly connect spent catalyst outlet 106 to a spent catalyst inlet 132 of a first regeneration stage 108 (conducted in first stage regenerator/combustor). First regeneration stage 108 is downstream from spent catalyst outlet 106. First regeneration stage 108 is configured and adapted to regenerate a spent catalyst from the stripper vessel 104. System 100 includes a second regeneration stage 110 (conducted in second stage regenerator/combustor) downstream from first regeneration stage. System 100 includes a first catalyst transfer line 118 for fluidly connecting first regeneration stage 108 to second regeneration stage 110. A partially regenerated catalyst from first regeneration stage 108 is supplied by first catalyst transfer line 118 to a catalyst inlet 140 of second regeneration stage 110. Second regeneration stage 110 configured and adapted to fully regenerate the partially regenerated catalyst from first regeneration stage 108. Second regeneration stage 110 is in fluid communication with the stripper vessel 104. Second regeneration stage 110 includes its own flue gas outlet line 116.

With continued reference to FIG. 1, stripper vessel 104 is configured and adapted to receive a spent catalyst from riser reactor 102 and a second portion of a fully regenerated catalyst from second regeneration stage 110 to mix with the spent catalyst for better stripping efficiency and prompting further reactions, which will result in overall reduce coke load, sulfur and nitrogen to be burned. Riser reactor 102 is upstream from stripper vessel 104 and in fluid communication with second regeneration stage 110. Riser reactor 102 is configured and adapted to receive a first portion of a fully regenerated catalyst from second regeneration stage 110. Second regeneration stage 110 operates at a targeted regeneration temperature ranging from 675° C. (1250° F.) to 815° C. (1500° F.), and/or 725° C. (1337° F.) to 760° C. (1400° F.) if needed with catalyst cooler. In some embodiments, second regeneration stage 110 operates at a pressure ranging from 15 psig (1.03 atm) to 50 psig (3.45 atm), and or from 17 to 20 psig (1.17-1.38 barg).

With continued reference to FIG. 1, a residence time for the partially regenerated catalyst in second regeneration stage 110 ranges from 0.5-10 min, and/or 2-5 min, in some embodiments. In second regeneration stage 110, the counter-current between the catalyst entering at inlet 140 and a regeneration gas stream 144 entering at regeneration gas inlet 142 has superficial velocity of regeneration gas preferably set at 2 fps (0.6 m/s) −4 fps (1.2 m/s). Regeneration gas stream 144 is an artificially created mixture comprising (1) pure oxygen from pure oxygen stream 146, (2) pure oxygen stream 146 and CO₂, e.g., CO₂ from a recycled CO₂ stream 148, or a mixture of oxygen and CO₂. The oxycombustion in second regeneration stage 110 is beneficial to smaller regenerator design and CO₂ capture and utility. Concentration levels for the mixture of oxygen and CO₂ can range from 0 to 50 mol % for oxygen (preferably around 25 to 30 mol %), 0 to 75 mol % for CO₂ (preferably around 70 to 75 mol %). In some embodiments, the regeneration gas is around 30 mol % oxygen and 70% CO₂ on a dry basis. Second regeneration stage 110 enables 50% to 80% of carbon removed as flue gas with high content of CO₂ (over 90 mol %), in which oxygen concentration can be preferably varied at 1-5 mol % and maximum CO concentration can be gained at 200 ppm vol. CRC (Coke on Regenerated Catalyst) can be reduced to 0.15 wt % or less, typically 0.05 wt % to 0.1 wt %.

With continued reference to FIG. 1, system 100 includes a supplemental heat source 112 in thermal communication with stripper vessel 104. Supplemental heat source 112 allows for stripper vessel 104 to reach higher temperatures than those of traditional stripper vessels. In accordance with some embodiments, stripper vessel is operated at around 500° C. (932° F.)−820° C. (1508° F.). In accordance with some embodiments, stripper vessel is operated at a pressure ranging from 12-30 psig (0.83-2.07 barg). A stripper bed 138 within stripper vessel 104 has a temperature from 55° C. (122° F.) above ROT (Riser reactor Outlet Temperature) to 815° C. (1500° F.), in some embodiments, preferably from 83° C. (150° F.) above ROT to 760° C. (1400° F.), and in some embodiments, preferably from 100° C. (212° F.) above ROT to 732° C. (1350° F.). It is contemplated that in some embodiments, the process can include running the first regeneration stage as a gasifier, such that the gasification is integrated into the FCC process. The first regeneration stage can include a raw synthesis gas outlet line.

As shown in FIG. 1, first regeneration stage 108 runs as a gasifier and includes its own raw synthesis gas outlet 111 and its own raw synthesis gas outlet line 114. System 100 includes a Fischer-Tropsch (F-T) process and a Water Gas Shift (WGS) process downstream from outlet 111. First regeneration stage 108 includes a gasification gas inlet 124. Those skilled in the art will readily appreciate that raw synthesis gas at outlet line 114 comprises at least one of CO, H₂, CO₂, H₂O, COS, H₂S, SOₓ, NOₓ or unreacted O₂. In some embodiments, system 100 includes a supplemental heat source 134 in thermal communication with first regeneration stage 108 to supply heat within the vessel of the first regeneration stage 108 and the incoming gasification gas coming in at gasification gas inlet 124. The process can include exchanging heat between hot flue gas/syngas and gasification gas to heat the gasification gas to a temperature above 425° C. (800° F.), preferably above 537° C. (1000° F.). The gasification occurring at first regenerator stage 108 acts to convert 10% to 70% of the deposited carbon to syngas. More specifically, in embodiments of the present disclosure, 20% to 50% of carbon is removed as raw syngas and the resulted partially regenerated catalyst comprising 0.3 wt % to 0.8 wt % deposited carbon. First regeneration stage 108 operates at a targeted gasification condition temperature ranging from 705° C. (1300° F.) to 820° C. (1508° F.). In some embodiments, first regeneration stage 108 operates at a targeted gasification condition pressure ranging from 30-35 psig (2.1-2.4 barg).

As shown in FIG. 1, in some embodiments, gasification gas is an artificially created mixture comprising at least one of i) oxygen and steam, ii) oxygen and CO₂, or iii) steam, oxygen and CO₂. The oxygen and/or steam stream is shown by a feed line 126, and the CO₂ stream is shown by feed line 128, which can be a recycled CO₂ stream. The oxycombustion in first regeneration stage 108 is beneficial to smaller regenerator design and CO₂ capture and utility. In some embodiments, the recycled CO₂ stream (feed lines 128 and 148) can be sourced from gasifier (first regeneration stage 108) and second stage regenerator 110. Flue gas output line 116 and downstream products of the raw synthesis gas outlet line 114 eventually feed into a CO₂ purification and recovery system and, after necessary pre-conditioning (Removal solid fines, SOₓ, NOₓ and/or moisture etc.), can be blended with O₂ and used as efficient gasification gas in the gasifier to produce syngas.

With continued reference to FIG. 1, flue gas outlet line 116 largely contains enriched CO₂. Second regeneration stage 110 is run as a complete regenerator/combustor, which acts to release the heat needed for feed vaporization, FCC reactions, hotter stripping, and coke gasification. The complete regenerated catalyst will be continuously divided to two routes: a regenerated catalyst transfer line 120 to return to riser reactor 102; and a second regenerated catalyst transfer line 122 to the hotter stripper 104. The flue gas from second regeneration stage 110 has no direct impacts to syngas produced at the first stage gasifier (e.g. first regeneration stage 108). System 100 includes regenerated catalyst transfer line 120 to fluidly connect second regenerator stage 110 to riser reactor 104 such that second regenerator stage 110 can provide hot regenerated catalyst thereto.

As shown in FIG. 1, system 100 includes second regenerated catalyst transfer line 122 for fluidly connecting second regenerator stage 110 to stripper vessel 104 such that second regenerator stage 110 can provide hot regenerated catalyst thereto. The hot regenerated catalyst from regenerator stage 110 allows for hotter stripping temperatures in stripper vessel 104. A hotter stripper benefits from higher stripping efficiency at higher temperature by physical desorption and chemical reactions. The higher stripper temperatures result in reduced regenerator coke load by 30-50%, reduced regenerator hydrogen molecular by 50-80%, reduced regenerator sulfur by 35-55% as H₂S and mercaptans, and reduced regenerator nitrogen as ammonia and cyanides. These aforementioned reductions are the result of less strippable hydrocarbon, S and N deposited on spent catalyst before spent catalyst enters into the regenerator section at spend catalyst inlet 132 (firstly to first stage regenerator, and then second stage regenerator) because of better/hotter stripper benefits. Therefore, total amount of both flue gas from second stage regenerator and syngas from first stage regenerator will be decreased, while the riser reactor section can recover those mentioned reductions as high-valued FCC products. The mixture of spent catalyst and regenerated catalyst from the hotter stripper will provide the necessary heat needed for the following coke gasification in first stage regenerator 108 to produce synthesis gas. Hotter stripper vessel operation also facilitates easier and more feasible integration with coke gasification for high carbon efficiency because of its heat coupling and heat balance.

In accordance with another aspect, a fluid catalytic cracking process, e.g., for an FCC system 100, includes regenerating a spent catalyst from a stripper vessel, e.g., stripper vessel 104, in a first regeneration stage, e.g., first regeneration stage 108, to produce a partially regenerated catalyst. In some embodiments, regenerating the spent catalyst from the stripper vessel in the first regeneration stage includes reacting the spent catalyst with gasification gas from a gasification gas inlet, e.g., gasification gas inlet 124, to produce the partially regenerated catalyst. In certain embodiments, the process includes supplying a heat source, e.g., a heat source 134, to the gasification gas in the first regeneration source. The process can include exchanging heat between hot flue gas/syngas and gasification gas to heat the gasification gas to a temperature above 425° C. (800° F.), preferably above 537° C. (1000° F.).

During the process, the first regeneration stage operates at a targeted gasification condition temperature ranging from 705° C. (1300° F.) to 820° C. (1508° F.). The first regeneration stage can operate at a targeted gasification condition temperature ranging from 750° C. (1382° F.) to 815° C. (1500° F.). In some embodiments, the first regeneration stage operates at a targeted gasification condition pressure ranging from 20 psig (1.38 atm) to 50 psig (3.45 atm), or 30-35 psig (2.1-2.4 barg), in certain embodiments. In some embodiments, a residence time for the spent catalyst in the first regeneration stage ranges from 0.5-30 minutes, or from 2-15 minutes. In the first regeneration stage, the counter-current between the catalyst entering at a spent catalyst inlet, e.g., spent catalyst inlet 132, and gasification gas from the gasification gas inlet can have a superficial velocity of gasification gas preferably set at 2 fps (0.6 m/s) −4 fps (1.2 m/s).

The process includes feeding the partially regenerated catalyst to a second regeneration stage, e.g., the second regeneration stage 110, by way of a transfer line, e.g, a first catalyst transfer line 118. The process includes regenerating the partially regenerated catalyst in the second regeneration stage, to produce a fully regenerated catalyst, and providing a first portion of the fully regenerated catalyst to a riser reactor, e.g., riser reactor 102, by way of a catalyst transfer line, e.g., the regenerated catalyst transfer line 120. In certain embodiments, providing the first portion of the fully regenerated catalyst to the riser reactor includes feeding the first portion of the fully regenerated catalyst through the first catalyst transfer line with a control valve, e.g. a control valve 136.

The process includes providing a second portion of the fully regenerated catalyst to the stripper vessel by way of a second regenerated catalyst transfer line, e.g., second catalyst transfer line 122. The process in accordance with the present disclosure includes generating the spent catalyst with the riser reactor and providing the spent catalyst to the stripper vessel. The addition of hot, regenerated catalyst to spent catalyst from the riser reactor acts to heat up the spent catalyst in the stripper vessel for better stripping efficiency and prompting further reactions, which will result in overall reduce coke load, sulfur and nitrogen to be burned, and providing necessary heat needed for the following coke gasification to produce synthesis gas in the first regeneration stage. The stripper vessel is operated at a temperature ranging from 500° C. (932° F.) to 820° C. (1508° F.). It is contemplated that the stripper vessel can be operated at a pressure ranging from 12-30 psig (0.83-2.07 barg). A stripper bed, e.g. stripper bed 138, within the stripper vessel can have a temperature from 55° C. (122° F.) above ROT to 815° C. (1500° F.), in some embodiments, preferably from 83° C. (150° F.) above ROT to 760° C. (1400° F.), and in some embodiments, preferably from 100° C. (212° F.) above ROT to 732° C. (1350° F.). In some embodiments, the counter-current between the spent catalyst and stripping media, preferably stripper superficial medium (preferably steam), can range from 0.5 fps (157 mm/s) to 1.0 fps (305 mm/s). In some embodiments, the process includes providing heat exchange between hot flue gas/syngas and stripper gas for high stripper temperature if needed. The process includes emitting a flue gas stream from the second regeneration stage to a flue gas outlet line, e.g., flue gas outlet line 116.

With continued reference to FIG. 1, in accordance with the processes of the embodiments of the present disclosure, the stripper vessel is operated at a temperature ranging from 500° C. (932° F.) to 820° C. (1508° F.). It is contemplated that the stripper vessel can be operated at a pressure ranging from 12-30 psig (0.83-2.07 barg) for basing unit pressure balance. Pressure balance is the basis of stable and continuous fluid flow loop of catalyst between reactor and regenerators. Riser reactor pressure, stripper pressure and regenerators' pressure are set for proper drive force to catalyst movement through different pressure push and potential energy changes. A stripper bed, e.g. stripper bed 138, within the stripper vessel can have a temperature from 55° C. (122° F.) above ROT to 815° C. (1500° F.), in some embodiments, preferably from 83° C. (150° F.) above ROT to 760° C. (1400° F.), and in some embodiments, preferably from 100° C. (212° F.) above ROT to 732° C. (1350° F.). In some embodiments, the spent catalyst residence time in the stripper vessel can range from 0.5-7 minutes, or, in some embodiments, from 1-3 minutes. It is contemplated that in some embodiments, the ratio of the hot fully regenerated catalyst to the spent catalyst in the stripper vessel ranges from 0.3:1 to 0.7:1, from 1:5 to 5:1, or from 1:10 to 10:1, depending on the stripping temperature desired.

The process includes transferring the spent catalyst stream to the first regeneration stage via a spent catalyst transfer line, e.g., spent catalyst transfer line 130. The process includes reacting a portion of the spent catalyst stream from the stripper vessel with gasification gas in the first regeneration stage to produce raw synthesis gas that exits the first regeneration stage via a raw synthesis gas outlet line, e.g., raw synthesis gas outlet line 114. In certain embodiments, the raw synthesis gas can include at least one of CO, H₂, CO₂, H₂O, COS, H₂S, SOₓ, NOₓ or unreacted O₂. It is contemplated that the oxygen concentration for the raw synthesis gas in the outlet line can be 0.2 mol % (Dry basis), most preferably no remaining oxygen. In some embodiments, concentration levels for these three main components can range from 0 to 50 mol % for oxygen, 0 to 75 mol % for CO₂, and 0 to 75 mol % for steam. In some embodiments, concentration levels for these three main components can range from 25 to 30 mol %, 70 to 75 mol %, and 0 to 75 mol % for steam. In some embodiments, concentration levels can range from around 30 mol % for oxygen and 70 mol % for CO₂ on a dry basis.

The methods and systems of the present disclosure, as described above and shown in the drawings, provide for hotter stripper technologies with superior properties including improved stripping efficiency, reduced regenerator load, and reduced CO₂ contaminant emissions of SOₓ and NOₓ. The unique heat coupling achieved by integrating hotter stripper technology and coke gasification (in the first regenerator stage) is an effective way to high carbon efficiency. The systems and methods of the present invention can apply to FCC systems, or the like. While the systems, apparatuses, processes and methods of the subject disclosure have been shown and described with reference to preferred embodiments, those skilled in the art will readily appreciate that changes and/or modifications may be made thereto without departing from the scope of the subject disclosure.

What is claimed is:

1. A fluid catalytic cracking process comprising:
regenerating a spent catalyst from a stripper vessel in a first regeneration stage to produce a partially regenerated catalyst;
regenerating the partially regenerated catalyst in second regeneration stage to produce a fully regenerated catalyst;
providing a first portion of the fully regenerated catalyst to a riser reactor;
generating the spent catalyst with the riser reactor and providing the spent catalyst to a stripper vessel; and
providing a second portion of the fully regenerated catalyst to the stripper vessel to mix with the spent catalyst for better stripping efficiency and prompting further reactions, resulting in overall reduced coke load, sulfur, and nitrogen to be burned, and providing necessary heat needed for the following coke gasification to produce synthesis gas in the first regeneration stage.

2. The process as recited in claim 1, wherein the stripper vessel is operated at around 500° C. (932° F.)−820° C. (1508° F.).

3. The process as recited in claim 1, wherein the stripper vessel is operated at a pressure ranging from 12-30 psig (0.83-2.07 barg).

4. The process as recited in claim 1, wherein the spent catalyst residence time in the stripper vessel ranges from 0.5 to 7 minutes.

5. The process as recited in claim 1, wherein the ratio of the fully regenerated catalyst to the spent catalyst in the stripper vessel ranges from 0.3:1 to 0.7:1.

6. The process as recited in claim 1, further comprising running the first regeneration stage as a gasifier, wherein the first regeneration stage includes a raw synthesis gas outlet line.

7. The process as recited in claim 1, further comprising reacting a portion of the spent catalyst stream from the stripper vessel with gasification gas in the first regeneration stage to produce raw synthesis gas.

8. The process as recited in claim 1, wherein regenerating the spent catalyst from the stripper vessel in the first regeneration stage includes reacting the spent catalyst with gasification gas to produce the partially regenerated catalyst.

9. The process as recited in claim 1, wherein the gasification gas is an artificially created mixture comprising at least one of i) oxygen and steam, ii) oxygen and CO₂, or iii) steam, oxygen and CO₂.

10. The process as recited in claim 1, further comprising running the second regeneration stage as a complete combustion regenerator, wherein the second regeneration stage includes a flue gas outlet line.

11. The process as recited in claim 1, further comprising feeding the partially regenerated catalyst to the second regeneration stage through a catalyst transfer line.

12. The process as recited in claim 1, wherein providing the first portion of the fully regenerated catalyst to the riser reactor includes feeding the first portion of the fully regenerated catalyst through a catalyst transfer line with a control valve.

13. The process as recited in claim 1, wherein providing the second portion of the fully regenerated catalyst to the stripper vessel includes feeding the second portion of the fully regenerated catalyst through a catalyst transfer line with a control valve.

14. A fluid catalytic cracking system comprising:
a stripper vessel having a spent catalyst outlet;
a first regeneration stage downstream from the spent catalyst outlet and configured and adapted to regenerate a spent catalyst from the stripper vessel;
a second regeneration stage downstream from the first regeneration stage, the second regeneration stage configured and adapted to fully regenerate a partially regenerated catalyst from the first regeneration stage, wherein the second regeneration stage is in fluid communication with the stripper vessel; and
a riser reactor upstream from the stripper vessel and in fluid communication with the second regeneration stage, the riser reactor configured and adapted to receive a first portion of a fully regenerated catalyst from the second regeneration stage, wherein the stripper vessel is configured and adapted to receive a spent catalyst from the riser reactor and a second portion of a fully regenerated catalyst from the second regeneration stage to mix with the spent catalyst for better stripping efficiency and prompting further reactions.

15. The system as recited in claim 14, further comprising a supplemental heat source in thermal communication with the stripper vessel.

16. The system as recited in claim 14, wherein the stripper vessel is operated at around 500° C. (932° F.)−820° C. (1508° F.).

17. The system as recited in claim 14, wherein the stripper vessel is operated at a pressure ranging from 12-30 psig (0.83-2.07 barg).

18. The system as recited in claim 14, wherein the first regeneration stage includes a raw synthesis gas outlet line.

19. The system as recited in claim 14, further comprising a catalyst transfer line for fluidly connecting the second regenerator stage to the riser reactor.

20. The system as recited in claim 14, further comprising a catalyst transfer line for fluidly connecting the second regenerator stage to the stripper vessel.
